(19) United States
(12) Patent Application Publication
(10) Pub. No.: US 2024/0391047 A1
(43) Pub. Date: Nov. 28, 2024

(54) PIPE COATING REMOVAL APPARATUS

(71) Applicant: PIPELINE INDUCTION HEAT LTD, Burnley, Lancashire (GB)

(72) Inventors: Michael GEORGE, Burnley (GB); Patrick MCKENNA, Accrington (GB); Timothy BOND, Cypress, TX (US)

(21) Appl. No.: 18/696,887

(22) PCT Filed: Oct. 3, 2022
(86) PCT No.: PCT/IB2022/059437

§ 371 Date: Mar. 28, 2024

(30) Foreign Application Priority Data
Oct. 1, 2021 (GB) 2114073.6

(51) Int. Cl. B24B 27/033; B23C 3/00; B24B 5/04; B24B 5/36

(52) U.S. Cl. CPC B24B 27/033; B23C 3/002; B24B 5/04; B24B 5/363

(57) ABSTRACT

A pipe coating material removal apparatus, comprising a support frame, a subframe, and one or more coating material removal members. The subframe is supported by the support frame and is configured to rotate relative to the support frame at least partially around a subframe rotation axis. The subframe rotation axis is configured to be substantially coaxial with a longitudinal axis of a pipe to which the apparatus may be applied in use. The, or each, coating material removal member is rotatably mounted to the subframe to remove part of an exterior coating of a pipe. The apparatus is configured such that the one or more coating material removal members enable the removal of pipe coating material at orientations substantially parallel to, and inclined with respect to, the longitudinal axis of the pipe.

The present invention relates to the preparation of pipe coatings for the subsequent application of joint coatings, for coating joints between pipe sections of pipelines. The invention has particular utility for oil or gas pipeline field joints.

Pipelines in the oil and gas industry are typically formed from multiple lengths of steel pipe sections that are welded together end-to-end as they are being laid. To prevent corrosion of the steel pipe sections and to reduce heat loss of fluids transported by the pipelines, the pipe sections are coated with one or more protective and/or insulative layers, typically a multi-layer coating comprising, for example, an epoxy bottom layer (especially fusion-bonded epoxy, FBE) followed by one or more polyethylene (e.g. polypropylene and/or modified polypropylene) outer layer(s). The pipe sections are usually coated at a factory remote from the location in which they are to be laid. This is often referred to as factory-applied coating and it is generally more cost effective than coating pipe sections on site where they are laid. (“On site”, generally known as “in the field”, may be on land, or at sea from a pipe-laying ship.) At the factory, the coating is applied to the outside of the pipe sections and a short length (known as a “cutback” region) is left uncoated at each end of the pipe section. The uncoated ends are necessary to enable the steel pipe sections to be welded together to form the pipeline in the field. The welded uncoated ends, known as field joints, must be coated in order to provide the necessary protection and/or insulation, and such coating is known as the field joint coating.

To prepare a field joint region of the pipeline for the field joint coating, each end region of the factory coating is typically machined by hand using power tools to remove a thin top layer, so that any dirt and grease is removed, and so that there will be good adhesion between the factory coating material and the field joint coating material. Additionally, unless already present, chamfers or bevels are hand machined into the polyethylene layer(s) to provide a gradual decrease in thickness of the factory coating material in a direction towards the uncoated lengths of pipe sections. Furthermore, a short length, known as a “toe”, of the FBE material extending from each end portion of the polyethylene material is typically abraded to clean the external surface of the FBE material and to ensure good adhesion to the field joint coating material.

Field joints are commonly coated by means of an injection-moulded polypropylene (“IMPP”) coating process. The exposed steel pipe section ends are heated, e.g. by induction heating. A layer of powdered fusion-bonded epoxy primer is then typically applied to the heated pipe section ends, and a thin layer of polypropylene is typically applied to the FBE primer during the FBE curing time. The end regions of the factory-applied coating, including the chamfers, are then heated, e.g. by means of radiant (infrared) heating. The field joint is then completely enclosed in a heavy-duty mould that defines a cavity around the welded pipe joint, the uncoated ends of the pipe sections, and the end regions of the factory-applied coating. Heated molten polypropylene (or modified polypropylene) is then injected into the mould cavity, to fill the cavity, and is allowed to cool. Once the injection-moulded polypropylene has cooled and solidified, the mould is removed from the field joint, leaving the solidified polypropylene field joint coating in place. Other types of field joint coating processes are also known. For example, the injection-moulded polyurethane (IMPU) coating process uses a chemically curable urethane material instead of injecting polypropylene as the mould-infill material around the field joint.

Australian Patent No. AU 2012204047 B2 discloses an underwater pipeline coating removal apparatus for enabling a section of an underwater pipeline to be repaired or replaced. The apparatus comprises a rotating cutting tool for removal of an outer reinforced-concrete layer of the underwater pipe, a rotating milling tool for removal of polymer coating from the pipe, and a rotating brushing tool for removing a residual polymer coating layer. All three tools are arranged to move radially towards and away from the pipe, and each of them has an axis of rotation that is parallel to the longitudinal axis of the pipe.

German Patent No. DE 102004031756 B4 discloses an apparatus for applying a bevel or chamfer to the polymer coating of a pipe in preparation for a field joint coating. In use, the apparatus is fixed to the exterior surface of a pipe by means of a link chain and a tensioning helical spring, and the apparatus also includes wheels which allow rotation of the apparatus around the pipe circumference. The apparatus may be guided around the pipe by hand or by means of a drive arrangement. The apparatus includes a drive with a working head to produce the chamfer, and the drive is supported by a holding means which enables its height and degree of inclination relative to the pipe to be adjusted, so that the desired inclination angle of the chamfer, within a range of approximately 15 to 25 degrees to the pipe axis, can be produced.

There is a need to improve the process of preparing a pipeline field joint for the field joint coating.

In a first aspect, the present invention provides a pipe coating material removal apparatus according to claim 1 of the appended claims.

A second aspect of the invention provides a method of preparing a pipe coating in readiness for receiving a field-applied coating, according to claim 20 of the appended claims.

Preferred, and other optional, features of the invention are defined and described in the dependent claims.

Accordingly, a first aspect of the invention provides a pipe coating material removal apparatus, comprising: a support frame; a subframe supported by the support frame and configured to rotate relative to the support frame at least partially around a subframe rotation axis, the subframe rotation axis configured to be substantially coaxial with a longitudinal axis of a pipe to which the apparatus may be applied in use; and one or more coating material removal members rotatably mounted to the subframe to remove part of an exterior coating of a said pipe; wherein the apparatus is configured such that the one or more coating material removal members enable the removal of pipe coating material at orientations substantially parallel to, and inclined with respect to, the longitudinal axis of the pipe.

A second aspect of the invention provides a method of preparing a pipe coating in readiness for receiving a field-applied coating, comprising removing pipe coating material using an apparatus according to the first aspect of the invention.

It is to be understood that any feature, including any preferred feature, of any aspect of the invention may be a feature, including a preferred feature, of any other aspect of the invention.

The pipe preferably comprises a joint region, e.g. a field joint, between two pipe sections of a pipeline.

Preferably, the removal of pipe coating material at an orientation inclined with respect to the longitudinal axis of the pipe provides part of the pipe coating with a chamfered or bevelled external surface, or provides a clean new external surface of a pre-existing chamfered or bevelled section of the pipe coating material.

The one or more coating material removal members preferably is adjustable to enable the removal of pipe coating material at an orientation substantially parallel to, and inclined with respect to, the longitudinal axis of the pipe.

Advantageously, the one or more coating material removal members may be adjustable to enable the orientation of pipe coating material removal to be varied throughout a range or series of orientation angles and/or to enable a depth of pipe coating material removal to be varied. The range or series of orientation angles preferably has a lower limit of no more than 0 degrees and preferably has an upper limit of at least 20 degrees, more preferably at least 30 degrees, with respect to the longitudinal axis of the pipe.

Preferably, the one or more rotatable coating material removal members each comprise a rotatable milling cutter (e.g. a generally or substantially cylindrical milling cutter) or a rotatable grinding member or abrasive member. The, or each, grinding member or abrasive member preferably comprises a grinding wheel, or a flap wheel, e.g. a ceramic flap wheel, or a wire brush wheel. The, or each, coating material removal member preferably is rotatable by means of a motor, e.g. a pneumatic motor.

The pipe coating removal apparatus may further comprise a feed plate located on one side, or on each of two opposite sides, of the, or each, rotatable coating material removal member, preferably arranged to control or determine a depth of coating removed from the pipe by the coating material removal member in use. In some preferred embodiments, the, or each, feed plate is movably, preferably rotatably, mounted with respect to the rotatable coating material removal member, to accommodate misalignments between the coating material removal member and the pipe, in use.

An angle of orientation of a rotation axis of one or more coating material removal members (especially the, or each, milling cutter, where present) with respect to the subframe rotation axis preferably is adjustable to enable the orientation of pipe coating material removal to be varied. The angle of orientation of the rotation axis of the, or each, coating material removal member preferably is adjustable by means of an air-hydro cylinder, for example.

The depth of coating material removal by one or more coating material removal members (especially the, or each, milling cutter, where present) may advantageously be adjustable by means of a servo motor or actuator, for example. Preferably, the depth of coating material removal is settable with the aid of a mechanical contact member, preferably comprising one or more feed plates and/or one or more ball transfer units, arranged to contact an exterior surface of the pipe coating, in use.

The pipe coating material removal apparatus of the invention preferably further comprises one or more distance measuring sensors configured to enable the apparatus to control an operating position of one or more said coating material removal members relative to the external surface of the pipe or pipe coating in use. The, or each, distance measuring sensor may advantageously comprise, for example, at least one of: an inductive sensor; an eddy current sensor; an optical sensor; a laser sensor; a mechanical sensor; an ultrasonic sensor; and a capacitive sensor.

The pipe coating material removal apparatus of the invention preferably further comprises a longitudinally movable member, preferably a plate member, movably mounted on the subframe, and to which the, or each, coating material removal member is mounted for longitudinal positioning with respect to a said pipe. The movable member (e.g. plate member) preferably is longitudinally movable (e.g. slidable) with respect to the subframe by means of a linear servo motor or actuator mounted on the subframe.

The pipe coating material removal apparatus of the invention preferably includes a plurality of coating material removal members mounted on the subframe in one or more coating material removal subassemblies. Preferably, there may be a plurality of coating material removal subassemblies rotatably mounted to the subframe in one or more opposing pairs of coating material removal subassemblies, for example. Advantageously, the, or each, coating material removal subassembly may be movable relative to the subframe by means of a pneumatic cylinder, for example.

In some preferred embodiments of the invention, the pipe coating removal apparatus includes one or more laser sensors, preferably one or more 2-dimensional profile laser sensors, configured to locate profile features of the pipe coating. Preferably, the, or each, laser sensor is configured to locate profile features of the pipe coating, which profile feature locations are used to axially position the coating material removal members with respect to the pipe coating.

A preferred embodiment of the invention will now be described, by way of example, with reference to the accompanying drawings, of which:

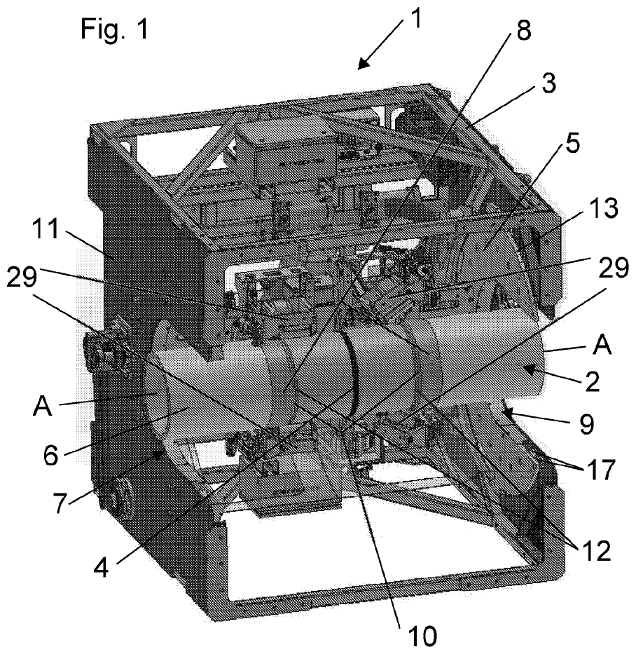

FIG. 1 schematically shows a pipe coating material removal apparatus of the invention in situ and working on a section of a pipeline;

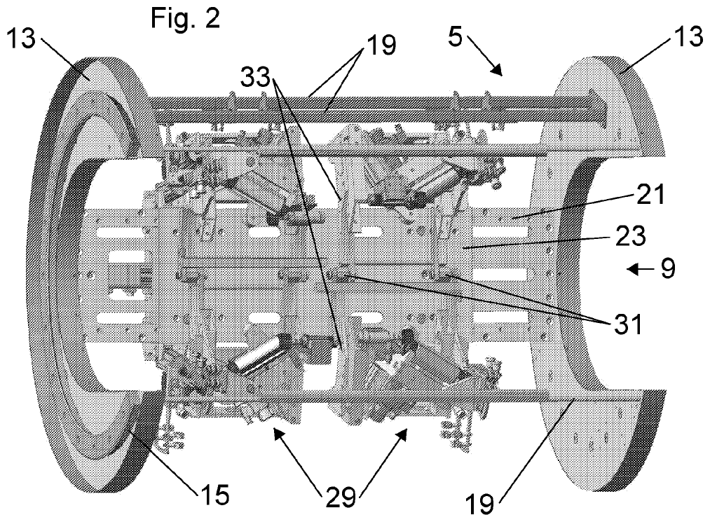

FIG. 2 shows a view of the apparatus of FIG. 1 with the outer support frame removed, for clarity;

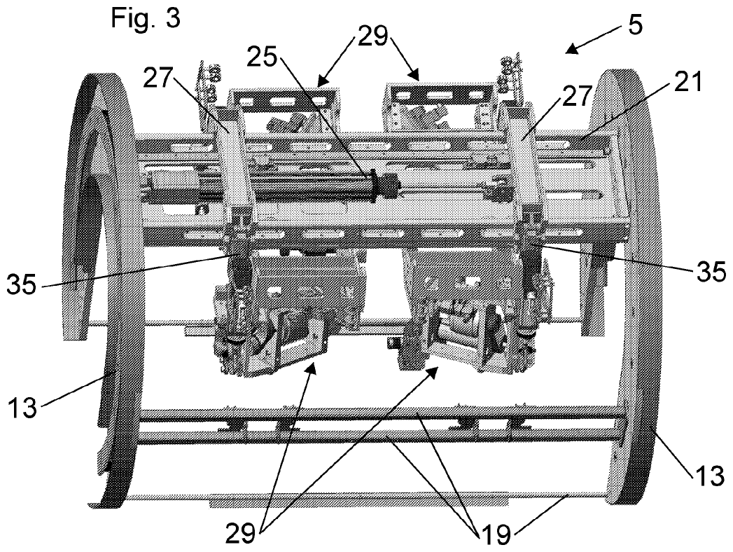

FIG. 3 shows another view of the apparatus of FIG. 1 with the outer support frame removed, for clarity;

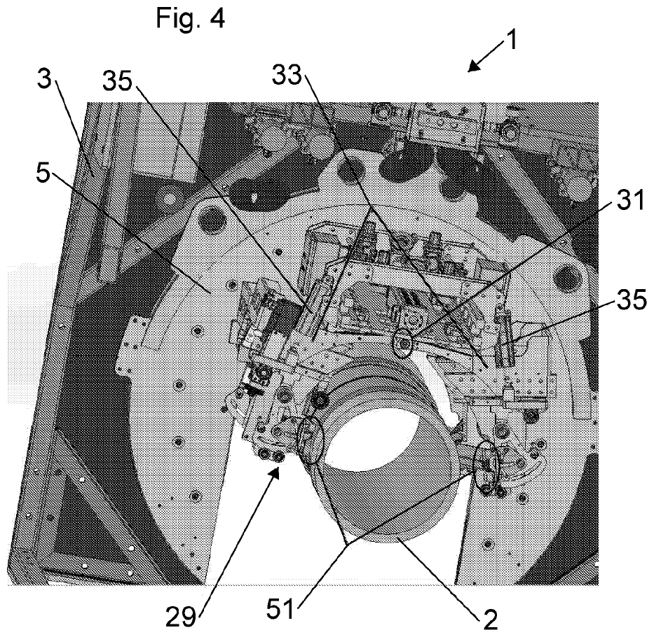

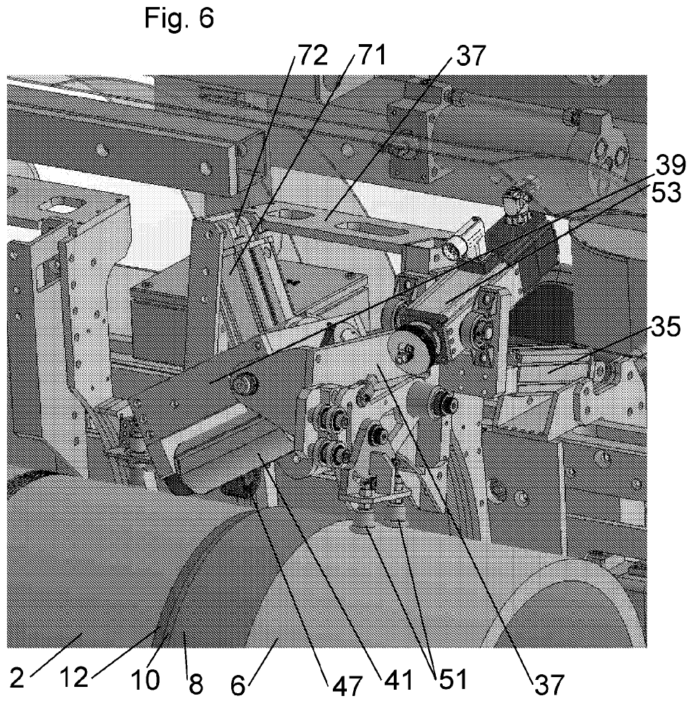

FIGS. 4 to 7 show various details of the apparatus of FIG. 1, from different perspectives;

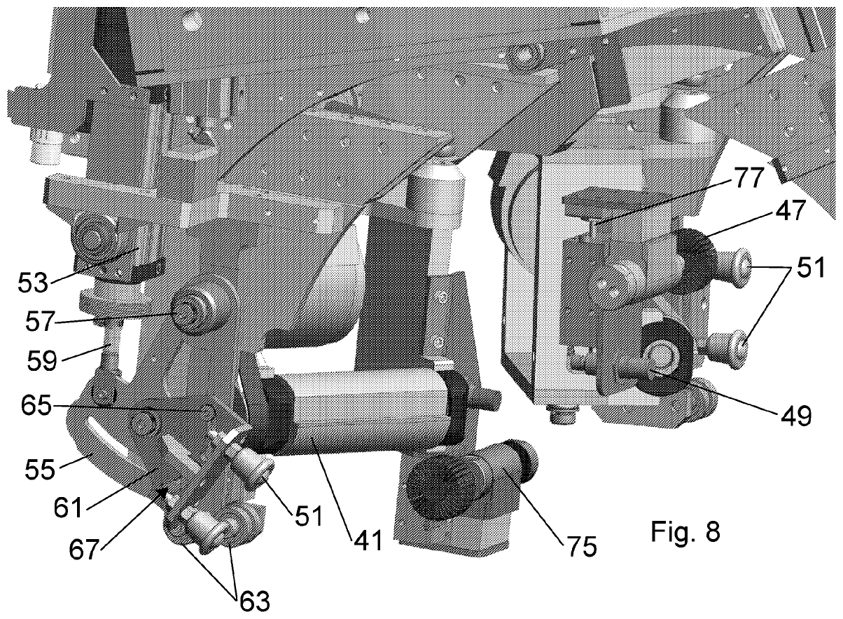

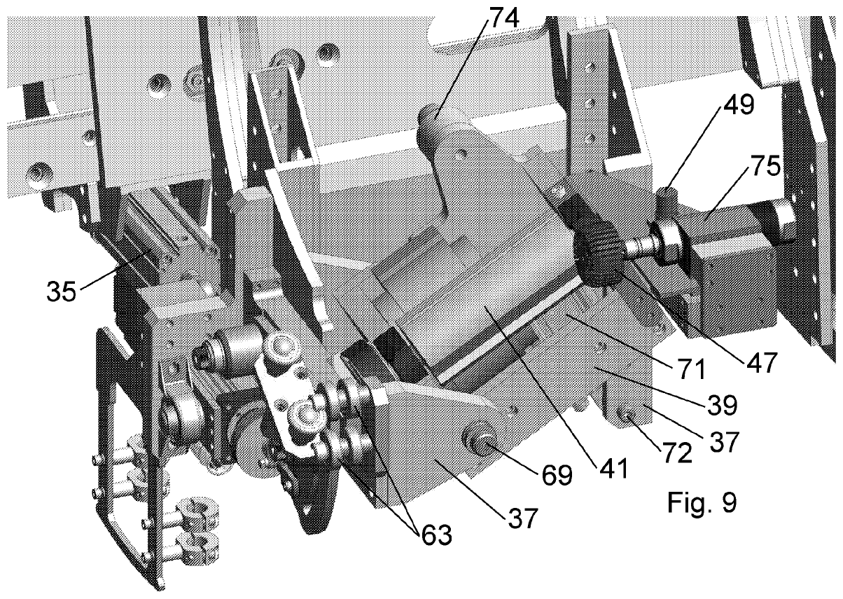

FIGS. 8 to 10 show various details of the apparatus as shown in FIGS. 2 and 3, from different perspectives; and

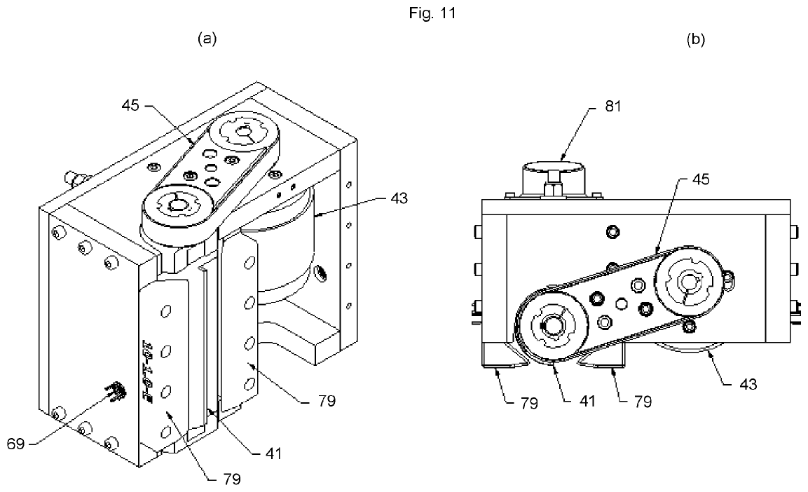

FIGS. 11 to 15 show various details of other embodiments of the invention.

Referring to FIG. 1, the illustrated exemplary embodiment of the invention comprises a pipe coating material removal apparatus 1 in situ and working on a pipe section 2 of a pipeline. The pipe coating material removal apparatus 1 comprises a support frame 3 and a subframe 5 supported by the support frame and configured to rotate relative to the support frame at least partially around a subframe rotation axis A. The subframe rotation axis A is configured to be substantially coaxial with the longitudinal axis of the pipe section 2 to which the apparatus 1 is applied, in use.

The illustrated support frame 3 comprises an outer steel frame of the apparatus 1, which supports the rest of the apparatus, including the subframe 5. The support frame 3 and the subframe 5 include wide slot-like openings 7 and 9 respectively, in respective opposite end wall parts 11 and 13 of each of the support frame 3 and the subframe 5, to allow the pipe section 2 to extend through the apparatus 1 with the longitudinal axis of the pipe section substantially coaxial with the subframe rotation axis A. The subframe 5 is mounted on the support frame 3 by means of a gear and drive system, comprising a large partial ring gear 15 (see FIG. 2) mounted on each end wall part 13 of the subframe 5, guided and supported by guide wheels 17 mounted on each end wall part 11 of the support frame. In use, the subframe 5 is rotated with respect to the support frame 3 by means of an electric motor (e.g. a 3-phase motor) mounted on the support frame 3, which drives at least one of the partial ring gears 15 by means of a chain or belt.

As shown in FIG. 1, the pipe section 2 comprises a field joint being prepared by the apparatus 1 for a subsequent field joint coating to be applied. The “cutback” regions (end portions containing no coating) of two pipe lengths have previously been welded together to form a weld join 4. As described above, to prepare the field joint region of the pipe section for the field joint coating, each end region of the factory coating 6 needs to be machined to remove a thin top layer of the polyethylene material (indicated by reference numeral 8), so that any dirt and grease is removed, and so that there will be good adhesion between the factory coating material and the field joint coating material. Additionally, chamfers or bevels 10 need to be machined into the polyethylene layer(s) of the factory coating to provide a gradual decrease in thickness of the factory coating material in a direction towards the uncoated lengths of pipe, or pre-existing such chamfers or bevels need to have a top layer of coating material removed from them, to provide a clean new exterior surface. Furthermore, a short length, known as a “toe”, of fusion-bonded epoxy (FBE) material 12 extending from each end portion of the polyethylene material typically needs to be abraded to clean the external surface of the FBE material and to ensure good adhesion to the field joint coating material. The apparatus 1 of the invention is constructed and configured to carry out these preparation steps, preferably automatically, following setup of the apparatus 1 around the field joint.

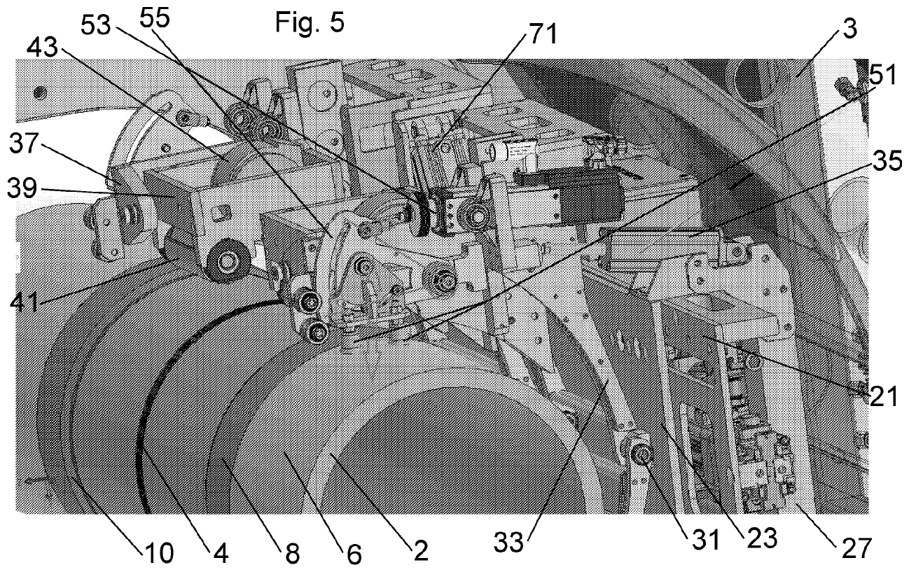

FIGS. 2 and 3 show views of the apparatus of FIG. 1 with the outer support frame 3 removed, for clarity. In these views, the subframe 5 can clearly be seen; it comprises a pair of opposing end wall parts 13 interconnected by a plurality of elongate struts 19 and an elongate slotted substructure 21. The substructure 21 is connected to each end wall part 13 at a position diametrically opposite the wide slot-like opening 9 which receives the pipe section 2 in use. The substructure 21 supports a plate member 23 which is movable (e.g. by sliding) longitudinally along the radial interior face of the substructure parallel to the subframe rotation axis A, by means of a linear servo motor 25 located on a radial exterior of the substructure 21. The plate member 23 includes a spaced-apart pair of short beams 27 which extend across the radial exterior of the substructure 21. The plate member 23, including the beams 27, supports a plurality of coating material removal subassemblies 29, four of which are included in the illustrated embodiment (but more, or fewer, could instead be included). As also shown in FIGS. 4 and 5, each of the coating material removal subassemblies 29 is rotatably mounted to the plate member 23 by hinges 31, in a generally “gullwing” arrangement of opposing pairs of substantially mirror-image subassemblies 29, including gullwing arms 33. Rotation of each coating material removal subassembly 29 about its respective hinge 31 is caused by means of a pneumatic cylinder 35 extending between each subassembly 29 and its respective beam 27. Pneumatic cylinders 35 are preferred for this purpose because they may advantageously allow a small amount of radial movement of the coating material removal subassemblies 29 as the subframe 5 is rotated at least partially around the pipe section 2, to allow for any small non-uniformities or misalignments.

In use, an opposing pair of coating material removal subassemblies 29 may be moved to the correct longitudinal position along the pipe section 2 to carry out the particular required coating material removal operation at that longitudinal position, by longitudinal movement (e.g. sliding) of the plate member 23 caused by control of the linear servo motor 25, for example by computer (e.g. utilizing an optical or laser sensor for longitudinal positioning) and/or human operator control via a control panel (not shown). Then, each coating material removal subassembly 29 of the longitudinally positioned opposing pair may be rotated towards the pipe section 2 about its hinge 31 on its gullwing arm 33 by means of its respective pneumatic cylinder 35, again by computer and/or human operator control, for example. For speed of operation, and also for balance and close positional control, both coating material removal subassemblies 29 of an opposing pair preferably are rotated into position to operate substantially at the same time at different circumferential locations on the pipe section 2, preferably substantially diametrically opposite locations.

In use, the subframe 5 is rotated relative to the support frame 3, at least partially around the pipe section 2, by the electric motor and the chain or belt, e.g. by computer and/or human operator control, so that each of the currently operating coating material removal subassemblies 29 removes the required coating from a respective circumferential region of the pipe section 2. Once the particular coating material removal operation required at that longitudinal position around the entire circumference of the pipe section 2 has been completed, the coating material removal subassemblies 29 may be rotated away from the pipe section 2 about their hinge 31 by their pneumatic cylinders 35, and any required further coating removal operations at different locations on the pipe section 2 may be carried out in a similar way.

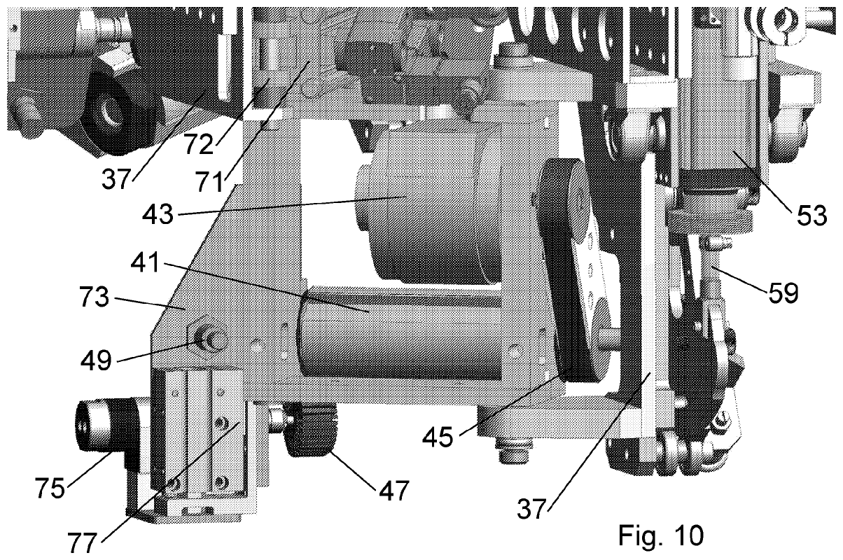

As shown in FIGS. 5 to 10, each coating material removal subassembly 29 comprises a mounting frame 37 mounted on a respective parallel pair of gullwing arms 33 (i.e. gullwing arms extending from the hinge 31 in the same direction, in parallel), and rotatably mounted on each mounting frame 37 is a subassembly frame 39. Each subassembly frame 39 supports: (i) a coating removal member in the form of a milling cutter 41 (preferably a generally or substantially cylindrical milling cutter); (ii) a pneumatic motor 43 arranged to rotate the milling cutter 41 by means of a belt drive 45 (see FIG. 10); (iii) a coating removal member in the form of a rotational grinding or abrasive member 47, e.g. a grinding wheel or an abrasive flap wheel (especially a ceramic flap wheel), driven by a small pneumatic motor 75; (iv) a solenoid actuator 77 (the function of which is explained below); and (v) a distance measuring sensor 49, e.g. an inductive sensor or eddy current sensor. (One or more other types of distance measuring sensor may additionally or alternatively be used, e.g. an optical sensor, a mechanical sensor (i.e. that senses distances by mechanical contact), an ultrasonic sensor, a capacitive sensor.)

Each mounting frame 37 also supports a mechanical contact member 51, e.g. in the form of one or more ball transfer units, arranged to contact the exterior surface of the factory-applied pipe coating 6 to limit the radially-inward travel of the gullwing arms 33 and to assist in setting the depth of coating material removal by each milling cutter 41. For parallel coating material removal (i.e. parallel to the pipe axis A) the cutting edge(s) of each milling cutter 41 are typically set at a position (equating to a coating material removal depth) approximately 0.5 mm radially inward of the radially inwardmost part(s) of the mechanical contact member 51. Preferably, as little coating material as possible is removed from the surface of the pipe section 2. The depth of coating material removal, by each milling cutter 41, is adjustable by means of a linear servo motor or actuator 53, preferably a high precision linear servo motor, supported by each mounting frame 37, which is configured to adjust the position of the mechanical contact member 51 relative to the milling cutter 41. This is achieved by each mechanical contact member 51 being mounted on a respective pivot arm 55 (in the form of a “quadrant arm” in the illustrated exemplary embodiment) which is pivotably mounted via a pivot 57 to its respective mounting frame 37, and a movable actuator arm 59 of the linear servo motor 53 being connected to the pivot arm 55 at a position spaced from the pivot 57. Each linear servo motor 53 is controllable by computer and/or human operator control, for example.

In the illustrated embodiment, each mechanical contact member 51 comprises a plurality of ball transfer units which can be kept automatically in contact with the exterior surface of the factory-applied pipe coating 6 by being mounted on a pivoting support 61 which itself is pivotally mounted to the respective pivot arm 55. The pivoting movement of each pivot arm 55 is guided by means of guide wheels 63 rotationally mounted on the respective mounting frame 37, and the pivoting movement of each pivoting support 61 is guided by means of projections 65 on the pivot arm 55 movably located in part-circular slots 67 on the pivoting support 61. (Other mechanical arrangements may additionally or alternatively be used, as will be understood by the skilled person.)

Each subassembly frame 39 is rotatably mounted on its mounting frame 37 by means of hinges 69, to enable the angle of orientation of the subassembly frame, with respect to the longitudinal axis of the pipe section 2, to be varied, thereby enabling the angle of orientation of each coating removal member 41, 47, with respect to the longitudinal axis of the pipe section 2, to be varied. The angle of orientation of each subassembly frame 39 is adjustable by means of an air-hydro cylinder 71 which extends between an attachment pivot 72 on each mounting frame 37 and an attachment pivot 74 on each respective subassembly frame 39. Air-hydro cylinders 71 are preferred for this purpose because of their rigidity once the orientation has been set. The operation of each air-hydro cylinder 71 is controllable by computer and/or human operator control, for example. The angle of orientation of each milling cutter 41 determines the chamfer or bevel angle of each chamfer or bevel 10 which is formed in the factory-applied coating 6 by the apparatus 1, this preferably being in the range of 20 to 35 degrees, e.g. substantially 30 degrees, for example. However, the operating orientation of each milling cutter 41 preferably is continuously variable through an entire range of angles elative to the subframe rotation axis A (which is substantially coaxial with the longitudinal axis of the pipe section, during operation of the apparatus 1). The range of angles preferably has a lower limit of no more than 0 degrees (i.e. at least parallel to axis A, and possibly including “negative” inclined angles). An upper limit of the range of angles may be at least 20 degrees, and preferably at least 30 degrees, for example. The ability to operate the milling cutters 41 at substantially any angle within a range of angles enables different chamfer/bevel angles to be used (e.g. depending on specific requirements), and may also enable the provision of a smooth (rather than stepped) transition between milled and nonmilled coating regions, for example.

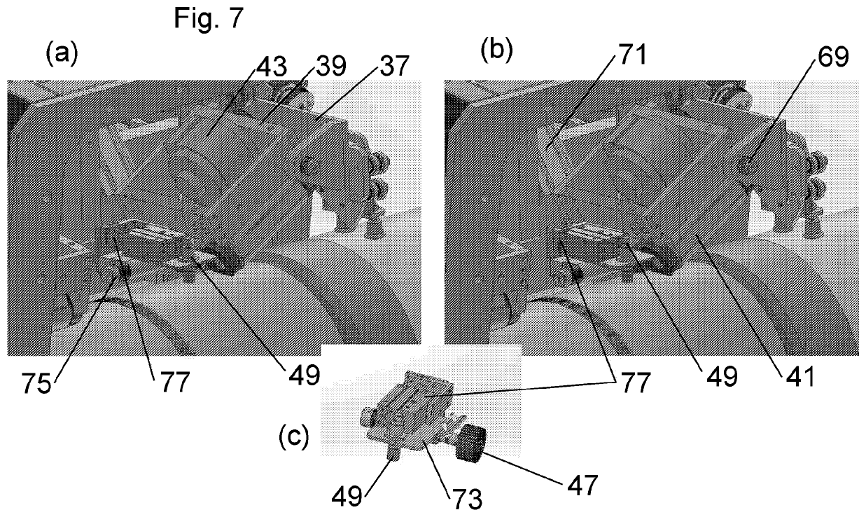

As mentioned above, and as best shown in FIGS. 7 to 10, each subassembly frame 39 also supports another coating removal member in the form of a rotational grinding or abrasive member 47, e.g. a grinding wheel or an abrasive flap wheel. Additionally, each subassembly frame 39 supports a distance measuring sensor 49, e.g. an inductive sensor or eddy current sensor (and/or one or more other types of sensor, as indicated above). In the illustrated exemplary embodiment, both the rotational abrasive member 47 and the distance measuring sensor 49 are mounted on a mounting plate 73 such that their rotational and longitudinal axes (respectively) are inclined with respect to the rotational axis of the milling cutter 41. In the illustrated embodiment, the rotational axis of the rotational abrasive member 47 is inclined at approximately 30 degrees to the rotational axis of the milling cutter 41, and the longitudinal axis of the (elongate) eddy current sensor (or other distance measuring sensor 49) is substantially perpendicular the rotational axis of the rotational abrasive member 47 and therefore is inclined at approximately 60 degrees to the rotational axis of the milling cutter 41. This inclined mounting of the rotational abrasive member 47 and the distance measuring sensor 49 helps to ensure that the milling cutter 41 is spaced from the pipe section 2 during their operation.

The rotational abrasive member 47 is powered by a pneumatic motor 75, and preferably is brought into operation to abrade and clean the external surface of the “toe” of fusion-bonded epoxy (FBE) material 12 and to ensure good adhesion to the subsequently-applied field joint coating material, preferably after the chamfers or bevels 10 have been formed in the polyethylene layer 8 of the factory coating 6. The correct radial positioning of the rotational abrasive member 47 relative to the exterior surface of the steel pipe section 2 is controlled by means of the distance measuring sensor 49 and a computer controller (not shown). Advantageously, the sensor-computer system may determine the distance between the sensor 49 and the pipe surface, and make any necessary distance corrections, several times per second during operation. In some preferred implementations of the invention, the depth of coating material removal by the milling cutter 41 is also controlled with reference to distance measurements made by the distance measuring sensor 49, e.g. using proportionality parameters to set the correct material removal depth(s).

When not in operation, the rotational abrasive member 47 is held in an extended “parked” position as shown in FIG. 7(a) in which the abrasive member 47 is tangentially spaced apart from the exterior surface of the pipe section. In order to operate the abrasive member 47, it is moved into a retracted operational position along the pipe surface tangent so as to be radially closer thereto, as shown in FIG. 7(b). In the retracted operational position the abrasive member 47 is able to contact the exterior surface of the pipe section 2 under the distance control of the distance measuring sensor 49 and computer control system. The rotational abrasive member 47 is moved between its extended and retracted positions by means of a solenoid 77, for example. The operation of the rotational abrasive member 47 preferably is under substantially automatic computer control.

As described above, when the pipe coating removal operation(s) required at a particular longitudinal position of the pipe section 2 has/have been completed, the plate member 23 is moved longitudinally by the linear servo motor 25 with respect to the substructure 21 so that the appropriate coating removal subassemblies 29 may carry out any required further pipe coating removal operation(s) at one or more different longitudinal positions on the pipe section 2. Once all of the necessary pipe coating removal operations have been completed, the apparatus 1 may be removed from the pipe section 2 and the field joint coating operations may commence.

FIGS. 11 to 15 show various details of other slightly modified embodiments of the invention.

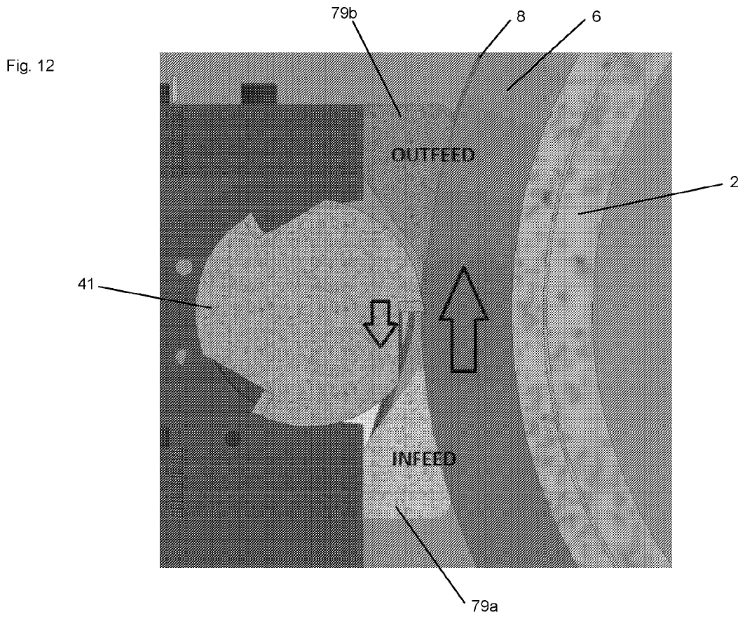

FIG. 11, views (a) and (b), and FIG. 12, show details of another embodiment of the apparatus of the invention, in which there is a feed plate 79 located on each of two opposites sides of the, or each, milling cutter 41 or other coating material removal member, the feed plates arranged substantially parallel to the axis of rotation of the milling cutter. As the milling cutter 41 (or other coating material removal member) is rotated around part of the circumference of the pipe section 2 to remove pipe coating material 6, one of the feed plates 79a (see FIG. 12) is situated in front of the cutter 41 in the direction of rotation of the milling cutter around the pipe section 2 and is referred to as the “infeed plate”, and the other feed plate 79b is situated behind the cutter 41 and is referred to as the “outfeed plate”.

The feed plates 79 are rigidly mounted relative to the axis of rotation of the milling cutter 41 such that the distance from the surface of the cutter to the running surface on the feed plates is constant. The feed plates act to passively control the depth of cut without the need for sophisticated controls. The feed plates 79 are configured to ensure a minimum amount of material is always removed from the factory coating 6 to present a clean “virgin” surface for the application of the field joint coating (injection moulded polypropylene), while accommodating variations in diameter, ovality and alignment, for example. Additionally, the feed plates 79 are configured to prevent the milling cutter 41 from removing an excessive amount of factory coating material 6, which can cause the cutter to stall and disrupt the coating preparation procedure. A further benefit of the feed plates 79 is to help with chip extraction. The feed plates 79 create a narrow channel to direct airflow and contain chips being thrown from the cutter 41. An extraction port 81 on the back of the cutter box can allow for the connection of dust extraction equipment and removal of the chips from the cutter assembly, for example.

A detail of factory coating material removal utilising feed plates 79a and 79b is shown in FIG. 12. At cut initiation, the cutter assembly is moved towards the pipe with the cutter 41 spinning, and the cutter touches the factory coating 6 to begin the cut. The cutter is driven into the factory coating 6 until the feed plates 79 contact the coating, at which point no further depth of material is removed. As cutting progresses, the main rotation assembly of the apparatus starts to revolve the cutter assembly around the pipe section. At this point, (assuming perfect alignment) the outfeed plate 79b no longer touches the factory coating 6 and it is only the infeed plate 79a that controls/limits the depth of cut. (In cases of extreme misalignment, the outfeed plate 79b may be touching the coating 6 and limiting the depth of cut, but this is not normal.) As the cut approaches completion (approaching the start of the cut from the opposing cutter) there comes a point when the infeed plate 79a no longer rides on the original outer diameter of the coating 6, but instead rides on the freshly cut surface. This causes the cutter 41 to briefly cut twice as deep right at the end of the cut. Once the full amount of rotation (e.g. 180 degrees) of the milling cutter 41 around part of the circumference of the pipe section 2 has been completed, the cutter 41 is withdrawn from the pipe.

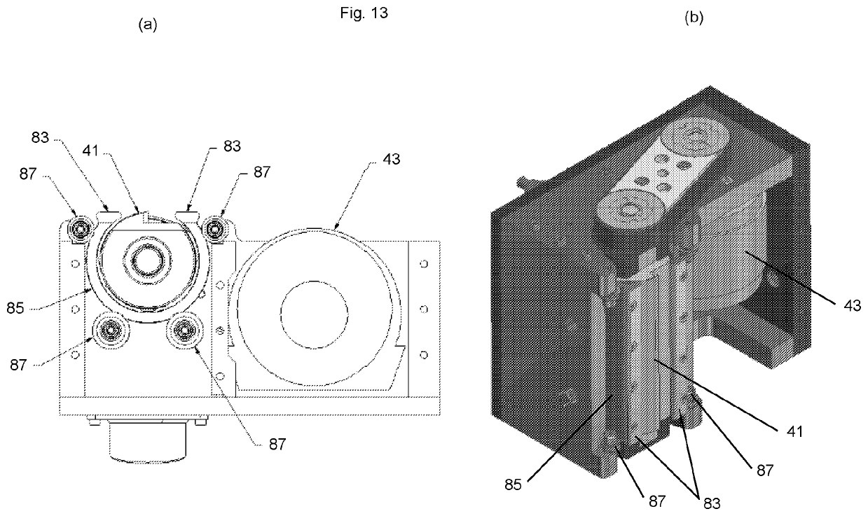

Views (a) and (b) of FIG. 13 show a variation on the embodiment shown in FIGS. 11 and 12, in which the feed plates are rotatably mounted with respect to the (or each respective) rotatable coating material removal member, to accommodate misalignments between the coating material removal member and the pipe, in use. In particular, in the embodiment shown in FIG. 13, the feed plates 83 are configured to roll around the cutter 41 to maintain a highly consistent depth of cut, regardless of the alignment of the pipe section with respect to the alignment of the main rotation axis of the apparatus. With the previously described embodiment of FIGS. 11 and 12, utilizing fixed feed plates 79, misalignment of the pipe section 2 skews the pipe section to one side of the cutter 41 which then reduces the depth of cut as the pipe section leans heavily on one feed plate instead of evenly on both. If the misalignment is extreme, the cutter 41 may not cut the surface of the coating 6 at all. With the embodiment shown in FIG. 13, the feed plates 83 are mounted to a supporting partial ring or partial cylinder 85 which is arranged around the cutter and rotationally supported by a plurality of guide bearings 87. With a misaligned pipe section 2, this mechanism allows the feed plates 83 to roll around the cutter 41 to directly face the pipe section, so that when initial contact is made between the cutter 41 and the pipe coating 6, both feed plates 83 then engage with the coating surface. This substantially ensures the depth of cut is consistent, regardless of pipe section alignment (preferably, within pre-defined acceptable limits).

The factory coating surface 6 to be prepared by the apparatus 1 according to the invention is generally not perfectly round, and its thickness generally varies along with the dimensions of the pipe 2 beneath. In addition to this, the pipe 2 may not be positioned in the exact centre of the apparatus corresponding to the axis of rotation of the subframe 5. These factors combined mean that as the, or each, coating material removal subassembly 29 rotates around the pipe 2, the location of the surface of the coating changes. As described above, each coating material subassembly 29 is mounted to a pneumatically actuated gullwing arm 33, which moves the subassembly 29 towards or away from the pipe and factory coating. With the embodiments of FIGS. 11 to 13, the pneumatic actuator 35 pushes the milling cutter 41 into the factory coating 6 until the feed plates 79/83 make contact with the surface of the factory coating and the cutter 41 can advance no further. As the cutter 41 rotates around the pipe 2 and the position of the surface of the coating varies, the pneumatic actuator 35 acts as a spring to accommodate these variations. The feed plates 79/83 and pneumatic gullwing arm 33 combined follow the varying surface of the factory coating 6, while maintaining a consistent depth of cut, preferably without the need for sophisticated controls.

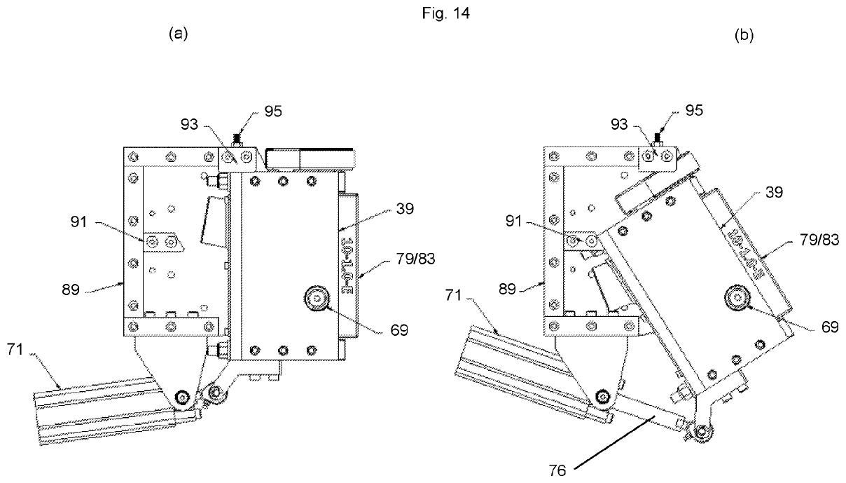

Views (a) and (b) of FIG. 14 show a subassembly frame 39 of an embodiment of the apparatus of the invention, in two different orientations. Depending on the project specifications, the milling cutters 41 may be used to clean the overlap and/or the chamfer. The overlap region is an area on the outer diameter of the factory coating 6 and requires the cutter to be approximately parallel to the axis of the pipe. The chamfer is a region where the polypropylene factory coating is reducing in diameter forming a conical or tapering surface with a typical angle of 30° to the pipe axis. For the chamfer region the cutter 41 must be positioned at this same 30° angle relative to the pipe axis. The angle of the chamfer can vary significantly (e.g. ˜) 5° such that this variance must be accounted for. As shown in FIG. 14, the cutter assembly is mounted to allow the milling cutter 41 to move between the required angles, with the angle of the milling cutter 41 being controlled primarily by the air-hydro cylinder 71.

In the embodiment shown in FIG. 14, the pivoting mechanism includes a pair of stops, 91 and 93, which are used to control the position of the milling cutter 41 for each pass (overlap and chamfer). In the case of the overlap pass, as shown in FIG. 14(a), the cutter angle is fixed, e.g. with the aid of the second stop 93. It can be fixed to be parallel to the pipe or have a slight angle ˜1° to “feather” the cut and blend it out at the edge. In the case of the chamfer pass, as shown in FIG. 14(b), the subassembly frame 39 of the milling cutter 41 is moved to the first stop 91, which sets the cutter 41 at an angle just greater than the maximum specified angle of the chamfer. The cutter subassembly frame 39 is then moved towards the pipe such that the cutter 41 first engages with the pipe close to the vertex between the chamfer and the polypropylene toe (on the chamfer face). The milling cutter 41 starts to cut and the feed plates 79/83 engage with the surface of the chamfer. The respective pneumatic cylinder 35 continues to push the milling cutter 41 towards the chamfer which in turn partially retracts the piston 76 of the air-hydro cylinder 71 and reduces the angle of the cutter until the angle of the cutter matches the angle of the chamfer. At this point, the system is stable and the milling cutter 41 can follow and adapt to the varying chamfer angle as the cutter assembly rotates around the pipe.

The chamfering pivot point preferably is substantially in-line with the chamfer coating surface from the reference point of the line of action of the swing arm. The force imparted by the air-hydro cylinder 71 to extend the milling cutter subassembly 39 to the initial chamfer angle against the first stop 91 must be light enough to be overcome by the force from the pneumatic cylinder 35, so that the piston 76 of the air-hydro cylinder 71 can be compressed to allow the milling cutter 41 to sit “flat” against the chamfer surface, thereby providing a passive system that matches the angle of the cutter to the angle of the chamfer without the need for sophisticated controls.

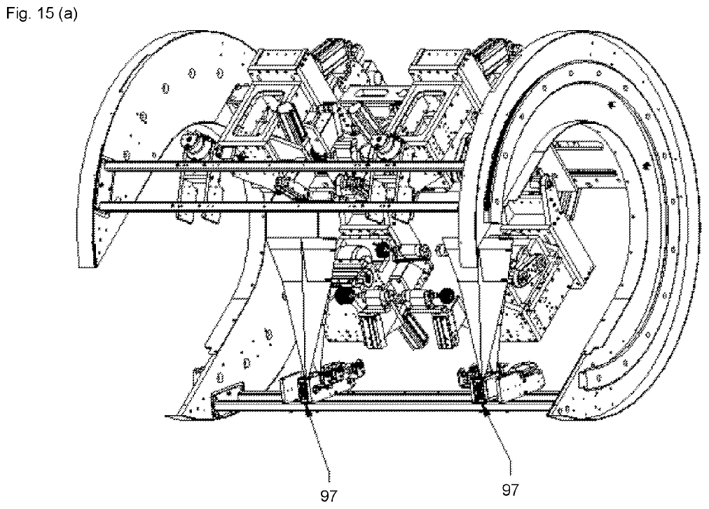

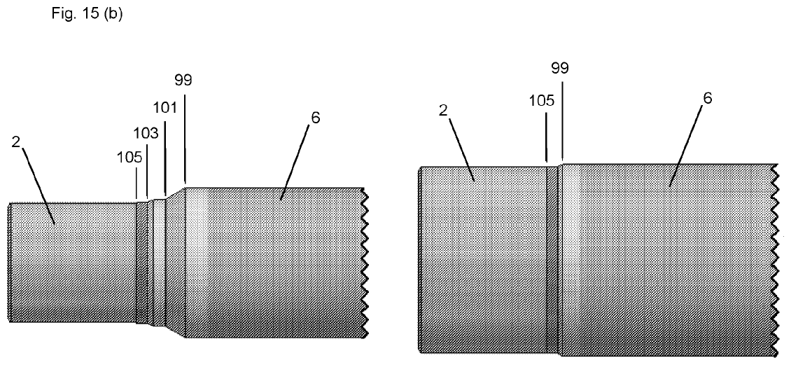

In some preferred embodiments of the invention, a first step in the method of preparing a pipe coating using the apparatus of the invention is to scan, e.g. laser scan, the factory coating and determine the location of the critical inflection points on the factory coating. The position of the pipe within the apparatus can vary along with the dimensions of the factory coating and the apparatus preferably is able to accommodate these variations automatically, without any operator input. Accordingly, in some preferred embodiments of the invention, and as shown in FIG. 15(a), the pipe coating removal apparatus includes one or more (preferably two) laser sensors 97, preferably one or more 2-dimensional profile laser sensors, configured to locate profile features of the pipe coating. Preferably, the laser sensor(s) are configured to locate profile features of the pipe coating, which profile location information is used to position the coating material removal subassemblies 29 linearly relative to the substructure 21, parallel to the axis of the pipe section, by the movement and positioning of the plate member 23 by means of a linear servo motor 25, as described above.

The, or each, laser sensor 97 may be selected such that its field of view is sufficient to detect all of the critical points across the acceptable range of pipe locations without the need to move or reposition the laser. Once the apparatus has been moved to the pipe, and the pipe is at a suitable position within the apparatus, the, or each, laser sensor 97 preferably scans the factory coating and using software and computer control determines X (pipe axial) and Y (pipe radial) coordinates for each of the inflection points 99, 101, 103, and 105, of the coating (see FIG. 15(b)). A computer control system of the apparatus preferably then uses the measured X coordinates to move the coating material removal subassemblies 29, including cutters 41, to the correct positions for each rotational pass of the subframe 5. FIG. 15(b) shows end regions of two different types of pipe sections, and indicates the critical points on the pipe coating that may be detected by the laser sensor(s), i.e. the “overlap start” 99, the “chamfer start” 101, the “polypropylene toe start” 103, and the “FBE toe start” 105.

It will be understood that the above description and the drawings are of particular example embodiments of the invention, but that other implementations and embodiments of the invention are included in the scope of the claims.

1. A pipe coating material removal apparatus, comprising: a support frame; a subframe supported by the support frame and configured to rotate relative to the support frame at least partially around a subframe rotation axis, the subframe rotation axis configured to be substantially coaxial with a longitudinal axis of a pipe to which the apparatus may be applied in use; one or more coating material removal members rotatably mounted to the subframe to remove part of an exterior coating of a said pipe; wherein the apparatus is configured such that the one or more coating material removal members enable the removal of pipe coating material at orientations substantially parallel to, and inclined with respect to, the longitudinal axis of the pipe; and feed plates located on each of two opposite sides of each rotatable coating material removal member, the feed plates arranged to control or determine a depth of coating removed from the pipe by a coating material removal member.

2. A pipe coating material removal apparatus according to claim 1, wherein the removal of pipe coating material at an orientation inclined with respect to the longitudinal axis of the pipe provides part of the pipe coating with a chamfered or bevelled external surface.

3. A pipe coating material removal apparatus according to claim 1, wherein one or more said coating material removal members is adjustable to enable the removal of pipe coating material at an orientation substantially parallel to, and inclined with respect to, the longitudinal axis of the pipe.

4. A pipe coating material removal apparatus according to claim 1, wherein one or more said coating material removal members is adjustable to enable the orientation of pipe coating material removal to be varied throughout a range or series of orientation angles and/or to enable a depth of pipe coating material removal to be varied.

5. A pipe coating material removal apparatus according to claim 4, wherein the range or series of orientation angles has a lower limit of no more than 0 degrees and an upper limit of at least 20 degrees, preferably at least 30 degrees, with respect to the longitudinal axis of the pipe.

6. A pipe coating material removal apparatus according to claim 4, wherein an angle of orientation of a rotation axis of one or more said coating material removal members with respect to the subframe rotation axis is adjustable to enable the orientation of pipe coating material removal to be varied.

7. A pipe coating material removal apparatus according to claim 1, wherein the one or more rotatable coating material removal members each comprise a milling cutter or a grinding member or an abrasive member.

8. A pipe coating material removal apparatus according to claim 7, wherein the, or each, grinding member or abrasive member comprises a grinding wheel, or a flap wheel comprising a ceramic flap wheel, or a wire brush wheel.

9. A pipe coating removal apparatus according to claim 1, wherein the feed plates are movably, preferably rotatably, mounted with respect to the rotatable coating material removal member, to accommodate misalignments between the coating material removal member and the pipe, in use.

10. A pipe coating material removal apparatus according to claim 1, further comprising one or more distance measuring sensors configured to enable the apparatus to control an operating position of one or more said coating material removal members relative to the external surface of the pipe or pipe coating in use.

11. A pipe coating material removal apparatus according to claim 10, wherein the, or each, distance measuring sensor comprises at least one of: an inductive sensor; an eddy current sensor; an optical sensor; a laser sensor; a mechanical sensor; an ultrasonic sensor; and a capacitive sensor.

12. A pipe coating material removal apparatus according to claim 1, further comprising a longitudinally movable member, preferably a plate member, movably mounted on the subframe, and to which the, or each, coating material removal member is mounted for longitudinal positioning with respect to a said pipe.

13. A pipe coating material removal apparatus according to claim 12, wherein the movable member is longitudinally movable with respect to the subframe by means of a linear servo motor or actuator mounted on the subframe.

14. A pipe coating material removal apparatus according to claim 1, including a plurality of coating material removal members mounted on the subframe in one or more coating material removal subassemblies.

15. A pipe coating material removal apparatus according to claim 14, comprising a plurality of coating material removal subassemblies rotatably mounted to the subframe in one or more opposing pairs of coating material removal subassemblies.

16. A pipe coating material removal apparatus according to claim 14, wherein the, or each, coating material removal subassembly is movable relative to the subframe by means of pneumatic cylinder.

17. A pipe coating material removal apparatus according to claim 4, wherein the depth of coating material removal is adjustable by means of a servo motor or actuator.

18. A pipe coating material removal apparatus according to claim 4, wherein the depth of coating material removal is settable with the aid of a mechanical contact member, preferably comprising the feed plates and/or one or more ball transfer units, arranged to contact an exterior surface of the pipe coating, in use.

19. A pipe coating material removal apparatus according to claim 6, wherein the angle of orientation of the rotation axis of the, or each, coating material removal member is adjustable by means of an air-hydro cylinder.

20. A pipe coating material removal apparatus according to claim 1, wherein the subframe is rotatable relative to the support frame and/or the, or each, coating material removal member is rotatable relative to the subframe, by means of one or more motors, preferably one or more electric and/or pneumatic motors.

21. A pipe coating removal apparatus according to claim 1, further comprising one or more laser sensors, preferably one or more 2-dimensional profile laser sensors, configured to locate profile features of the pipe coating.

22. A pipe coating removal apparatus according to claim 21, wherein the, or each, laser sensor is configured to locate profile features of the pipe coating, which profile feature locations are used to axially position the coating material removal members with respect to the pipe coating.

23. A method of preparing a pipe coating in readiness for receiving a field-applied coating, comprising removing pipe coating material using an apparatus according to claim 1.
